(19) United States
(12) Patent Application Publication
(10) Pub. No.: US 2024/0397470 A1
(43) Pub. Date: Nov. 28, 2024

(54) METHODS AND APPARATUSES FOR SIDELINK POSITIONING

(71) Applicant: LENOVO (BEIJING) LIMITED, Beijing (CN)

(72) Inventors: Jie HU, Beijing (CN); Jing HAN, Beijing (CN); Haiming WANG, Beijing (CN); Lianhai WU, Beijing (CN); Xiaodong YU, Beijing (CN)

(21) Appl. No.: 18/694,649

(22) PCT Filed: Sep. 24, 2021
(86) PCT No.: PCT/CN2021/120426

§ 371 Date: Mar. 22, 2024

(51) Int. Cl. H04W 64/00; H04W 8/00; H04W 8/22; H04W 92/18

(52) U.S. Cl. CPC H04W 64/00; H04W 8/005; H04W 8/22; H04W 92/18

(57) ABSTRACT

Disclosed are methods and apparatuses for sidelink positioning. An embodiment of the subject application provides a user equipment (UE). The UE includes: a processor, and a wireless transceiver coupled to the processor, wherein the processor is configured to determine one or more candidate sidelink (SL) anchor UEs and select at least one anchor UE for SL positioning from the one or more candidate SL anchor UEs.

### TECHNICAL FIELD

The present disclosure generally relates to wireless communication technologies, and especially to methods and apparatuses for sidelink (SL) positioning.

### BACKGROUND OF THE INVENTION

SL positioning refers to transmitting Positioning Reference Signal (PRS) over SL, which can operate independently of network or radio access technology (RAT) coverage and provide a new positioning method that fits new network use cases.

Service requirements for SL positioning have been defined in corresponding specification, e.g., the requirements for Vehicle-to-Everything (V2X) and public safety use case can also apply to SL positioning. Based on the specified requirements, solutions for SL positioning need be studied to support “both in coverage,” “partial coverage” and “both out of coverage” scenarios. Moreover, coordination procedures between user equipments (UEs) and between UE and network, and corresponding UE designs need be considered from RAN2's perspective for SL positioning designs.

### SUMMARY

Various embodiments of the present disclosure provide solutions related to how to perform SL anchor UE(s) selection and re-selection.

According to some embodiments of the present disclosure, a first UE is provided. The first UE includes: a processor and a wireless transceiver coupled to the processor, wherein the processor is configured to: determine one or more candidate SL anchor UEs, and select at least one anchor UE for SL positioning from the one or more candidate SL anchor UEs.

In some embodiments, the processor is configured to determine the one or more candidate SL anchor UEs based on a discovery procedure in a discovery layer.

In some embodiments, to determine the one or more candidate SL anchor UEs, the processor is configured to: receive, with the wireless transceiver, a discovery message containing positioning capability information of a second UE; and determine the second UE to be a candidate SL anchor UE.

In some embodiments, the processor is configured to determine the second UE to be a candidate SL anchor UE when a positioning capability of the second UE meets a criterion to serve as an anchor UE for the first UE.

In some embodiments, to determine the one or more candidate SL anchor UEs, the processor is configured to: transmit, with the wireless transceiver, a location service request; receive, with the wireless transceiver, a response message containing positioning capability information of a second UE; and determine the second UE to be a candidate SL anchor UE.

In some embodiments, the location service request contains at least one of an SL anchor UE discovery message and a criterion to serve as an anchor UE for the first UE.

In some embodiments, the processor is further configured to: establish an SL radio resource control (RRC) connection with the selected at least one anchor UE; and receive, with the wireless transceiver, positioning capability information of the selected at least one anchor UE in SL UE capability information from the selected at least one anchor UE.

In some embodiments, the processor is configured to determine the one or more candidate SL anchor UEs based on an SL UE capability transfer procedure.

In some embodiments, to determine the one or more candidate SL anchor UEs, the processor is configured to: transmit, with the wireless transceiver, a request for positioning capability information in an SL UE capability enquiry message to a second UE; receive, with the wireless transceiver, positioning capability information of the second UE in an SL UE capability information message from the second UE; and determine the second UE to be a candidate SL anchor UE after an SL RRC configuration with the second UE is completed.

In some embodiments, the processor is configured to transmit, with the wireless transceiver, the request for positioning capability information to the second UE when a positioning capability or criterion required for serving as an anchor UE for the first UE changes.

In some embodiments, to determine the one or more candidate SL anchor UEs, the processor is configured to: receive, with the wireless transceiver, SL PRS information from a second UE; and determine the second UE to be a candidate SL anchor UE.

In some embodiments, the SL PRS information contains information identifying the second UE.

In some embodiments, the SL PRS information is received in a dedicated time and frequency resource.

In some embodiments, the processor is further configured to: receive, with the wireless transceiver, an available SL PRS configuration from a location management function (LMF) via a long term evolution (LTE) positioning protocol (LPP) signaling, or from a base station via an RRC signaling.

In some embodiments, the processor is configured to select the at least one anchor UE for SL positioning from the one or more candidate SL anchor UEs based on at least one of the followings: positioning capability information of the one or more candidate SL anchor UEs; SL radio signal strength measurement results associated with the one or more candidate SL anchor UEs; or types of the one or more candidate SL anchor UEs.

In some embodiments, to select the at least one anchor UE for SL positioning from the one or more candidate SL anchor UEs, the processor is configured to: give a candidate SL anchor UE supporting global navigation satellite system (GNSS) positioning mode a higher priority to be selected than a candidate SL anchor UE supporting RAT-dependent positioning mode; and/or give a candidate SL anchor UE supporting a wider bandwidth a higher priority to be selected than a candidate SL anchor UE supporting a narrower bandwidth.

In some embodiments, to select the at least one anchor UE for SL positioning from the one or more candidate SL anchor UEs, the processor is configured to: give a candidate SL anchor UE with a higher radio signal strength of SL discovery message a higher priority to be selected than a candidate SL anchor UE with a lower radio signal strength of SL discovery message; and/or give a first candidate SL anchor UE with a higher SL reference signal received power (RSRP) value on an SL unicast link between the first candidate SL anchor UE and the first UE a higher priority to be selected than a second candidate SL anchor UE with a lower SL-RSRP value on an SL unicast link between the second candidate SL anchor UE and the first UE when the first candidate SL anchor UE and the second candidate SL anchor UE are connected to the first UE.

In some embodiments, the processor is configured to select at least one candidate SL anchor UE with a specific UE type to be the at least one anchor UE for SL positioning.

In some embodiments, the processor is further configured to: start a timer after selecting the at least one anchor UE for SL positioning; and prohibit SL anchor UE re-selection when the timer is running, wherein a value of the timer is pre-configured or configured by a network.

In some embodiments, the processor is further configured to perform SL anchor UE re-selection in response to at least one of the following conditions: a change in a positioning capability requirement of the first UE for SL positioning meets a first predefined condition; a change in a positioning capability of an anchor UE for SL positioning meets a second predefined condition; the first UE enters, leaves, or remains within a predefined area; the first UE moves by more than a predefined straight-line distance from a previous location; the first UE receives an SL anchor UE re-selection indication via an LPP signaling from an LMF, an RRC signaling from a base station, or from an anchor UE for SL positioning; no SL PRS information is received within a duration of a timer pre-configured or configured by a network, wherein the timer is shorter than a timer indicating a radio link failure; an SL-RSRP measurement value on an SL unicast link between the first UE and an anchor UE for SL positioning is within a specified threshold during a specified time window; or an SL radio link between the first UE and an anchor UE for SL positioning fails.

In some embodiments, the first predefined condition includes at least one of: a change in an accuracy requirement for SL positioning satisfies a specified threshold; or a change in a latency requirement for SL positioning satisfies a specified threshold.

In some embodiments, the second predefined condition includes at least one of the positioning capability of the anchor UE to support SL positioning for the first UE is unavailable; the anchor UE for SL positioning moves out of coverage of a network; or a total bandwidth available for making positioning measurements by the anchor UE for SL positioning is lower than a threshold.

According to some embodiments of the present disclosure, a second UE is provided. The second UE includes: a processor and a wireless transceiver coupled to the processor, wherein the processor is configured to perform at least one of transmitting, with the wireless transceiver, positioning capability information of the second UE, and transmitting, with the wireless transceiver, SL PRS information.

In some embodiments, the processor is configured to transmit, with the wireless transceiver, the positioning capability information of the second UE in a discovery message.

In some embodiments, the processor is configured to transmit, with the wireless transceiver, the positioning capability information of the second UE in a response message to a first UE in response to a location service request received from the first UE.

In some embodiments, the location service request contains at least one of an SL anchor UE discovery message and a criterion to serve as an anchor UE for the first UE.

In some embodiments, the processor is configured to transmit, with the wireless transceiver, the positioning capability information of the second UE to the first UE when a positioning capability of the second UE meets the criterion contained in the location service request.

In some embodiments, the processor is configured to transmit, with the wireless transceiver, the positioning capability information of the second UE in an SL UE capability information message to a first UE in response to a request for positioning capability information received in an SL UE capability enquiry message from the first UE.

In some embodiments, the processor is configured to transmit, with the wireless transceiver, the positioning capability information of the second UE when a positioning capability of the second UE changes.

In some embodiments, the SL PRS information contains information identifying the second UE.

In some embodiments, the processor is configured to transmit, with the wireless transceiver, the SL PRS information in a dedicated time and frequency resource.

In some embodiments, the processor is further configured to transmit, with the wireless transceiver, an indication of updated positioning capability to a first UE when a change in a positioning capability of the second UE meets a predefined condition, wherein the second UE is serving as an anchor UE for SL positioning of the first UE.

In some embodiments, the predefined condition includes at least one of the positioning capability of the second UE to support SL positioning for the first UE is unavailable; the second UE moves out of coverage of a network; or a total bandwidth available for making positioning measurements by the second UE is lower than a threshold.

In some embodiments, the processor is further configured to: receive, with the wireless transceiver, an SL anchor UE re-selection indication from a base station; and transmit, with the wireless transceiver, the SL anchor UE re-selection indication to a first UE, wherein the second UE is serving as an anchor UE for SL positioning of the first UE.

According to some embodiments of the present disclosure, a method performed by a first UE is provided. The method includes: determining one or more candidate SL anchor UEs and selecting at least one anchor UE for SL positioning from the one or more candidate SL anchor UEs.

In some embodiments, the one or more candidate SL anchor UEs are determined based on a discovery procedure in a discovery layer.

In some embodiments, determining the one or more candidate SL anchor UEs includes: receiving a discovery message containing positioning capability information of a second UE; and determining the second UE to be a candidate SL anchor UE.

In some embodiments, the second UE is determined to be a candidate SL anchor UE when a positioning capability of the second UE meets a criterion to serve as an anchor UE for the first UE.

In some embodiments, determining the one or more candidate SL anchor UEs includes: transmitting a location service request; receiving a response message containing positioning capability information of a second UE; and determining the second UE to be a candidate SL anchor UE.

In some embodiments, the location service request contains at least one of an SL anchor UE discovery message and a criterion to serve as an anchor UE for the first UE.

In some embodiments, the method further includes: establishing an SL RRC connection with the selected at least one anchor UE; and receiving positioning capability information of the selected at least one anchor UE in SL UE capability information from the selected at least one anchor UE.

In some embodiments, the one or more candidate SL anchor UEs are determined based on an SL UE capability transfer procedure.

In some embodiments, determining the one or more candidate SL anchor UEs includes: transmitting a request for positioning capability information in an SL UE capability enquiry message to a second UE; receiving positioning capability information of the second UE in an SL UE capability information message from the second UE; and determining the second UE to be a candidate SL anchor UE after an SL RRC configuration with the second UE is completed.

In some embodiments, the request for positioning capability information is transmitted to the second UE when a positioning capability or criterion required for serving as an anchor UE for the first UE changes.

In some embodiments, determining the one or more candidate SL anchor UEs includes: receiving SL PRS information from a second UE; and determining the second UE to be a candidate SL anchor UE.

In some embodiments, the SL PRS information contains information identifying the second UE.

In some embodiments, the SL PRS information is received in a dedicated time and frequency resource.

In some embodiments, the method further includes receiving an available SL PRS configuration from an LMF via an LPP signaling, or from a base station via an RRC signaling.

In some embodiments, the at least one anchor UE for SL positioning is selected from the one or more candidate SL anchor UEs based on at least one of the followings: positioning capability information of the one or more candidate SL anchor UEs; SL radio signal strength measurement results associated with the one or more candidate SL anchor UEs; or types of the one or more candidate SL anchor UEs.

In some embodiments, selecting the at least one anchor UE for SL positioning from the one or more candidate SL anchor UEs includes: giving a candidate SL anchor UE supporting GNSS positioning mode a higher priority to be selected than a candidate SL anchor UE supporting RAT-dependent positioning mode; and/or giving a candidate SL anchor UE supporting a wider bandwidth a higher priority to be selected than a candidate SL anchor UE supporting a narrower bandwidth.

In some embodiments, selecting the at least one anchor UE for SL positioning from the one or more candidate SL anchor UEs includes: giving a candidate SL anchor UE with a higher radio signal strength of SL discovery message a higher priority to be selected than a candidate SL anchor UE with a lower radio signal strength of SL discovery message; and/or giving a first candidate SL anchor UE with a higher SL RSRP value on an SL unicast link between the first candidate SL anchor UE and the first UE a higher priority to be selected than a second candidate SL anchor UE with a lower SL-RSRP value on an SL unicast link between the second candidate SL anchor UE and the first UE when the first candidate SL anchor UE and the second candidate SL anchor UE are connected to the first UE.

In some embodiments, at least one candidate SL anchor UE with a specific UE type is selected to be the at least one anchor UE for SL positioning.

In some embodiments, the method further includes: starting a timer after selecting the at least one anchor UE for SL positioning; and prohibiting SL anchor UE re-selection when the timer is running, wherein a value of the timer is pre-configured or configured by a network.

In some embodiments, the method further includes performing SL anchor UE re-selection in response to at least one of the following conditions: a change in a positioning capability requirement of the first UE for SL positioning meets a first predefined condition; a change in a positioning capability of an anchor UE for SL positioning meets a second predefined condition; the first UE enters, leaves, or remains within a predefined area; the first UE moves by more than a predefined straight-line distance from a previous location; the first UE receives an SL anchor UE re-selection indication via an LPP signaling from an LMF, an RRC signaling from a base station, or from an anchor UE for SL positioning; no SL PRS information is received within a duration of a timer pre-configured or configured by a network, wherein the timer is shorter than a timer indicating a radio link failure; an SL-RSRP measurement value on an SL unicast link between the first UE and an anchor UE for SL positioning is within a specified threshold during a specified time window; or an SL radio link between the first UE and an anchor UE for SL positioning fails.

In some embodiments, wherein the first predefined condition includes at least one of: a change in an accuracy requirement for SL positioning satisfies a specified threshold; or a change in a latency requirement for SL positioning satisfies a specified threshold.

In some embodiments, the second predefined condition includes at least one of the positioning capability of the anchor UE to support SL positioning for the first UE is unavailable; the anchor UE for SL positioning moves out of coverage of a network; or a total bandwidth available for making positioning measurements by the anchor UE for SL positioning is lower than a threshold.

According to some embodiments of the present disclosure, a method performed by a second UE is provided. The method includes: transmitting positioning capability information of the second UE and/or transmitting SL PRS information.

In some embodiments, the positioning capability information of the second UE is transmitted in a discovery message.

In some embodiments, the positioning capability information of the second UE is transmitted in a response message to a first UE in response to a location service request received from the first UE.

In some embodiments, the location service request contains at least one of an SL anchor UE discovery message and a criterion to serve as an anchor UE for the first UE.

In some embodiments, the positioning capability information of the second UE is transmitted to the first UE when a positioning capability of the second UE meets the criterion contained in the location service request.

In some embodiments, the positioning capability information of the second UE is transmitted in an SL UE capability information message to a first UE in response to a request for positioning capability information received in an SL UE capability enquiry message from the first UE.

In some embodiments, the positioning capability information of the second UE is transmitted when a positioning capability of the second UE changes.

In some embodiments, the SL PRS information contains information identifying the second UE.

In some embodiments, the SL PRS information is transmitted in a dedicated time and frequency resource.

In some embodiments, the method further includes transmitting an indication of updated positioning capability to a first UE when a change in a positioning capability of the second UE meets a predefined condition, wherein the second UE is serving as an anchor UE for SL positioning of the first UE.

In some embodiments, the predefined condition includes at least one of the positioning capability of the second UE to support SL positioning for the first UE is unavailable; the second UE moves out of coverage of a network; or a total bandwidth available for making positioning measurements by the second UE is lower than a threshold.

In some embodiments, the method further includes: receiving an SL anchor UE re-selection indication from a base station; and transmitting the SL anchor UE re-selection indication to a first UE, wherein the second UE is serving as an anchor UE for SL positioning of the first UE.

### BRIEF DESCRIPTION OF THE DRAWINGS

In order to describe the manner in which advantages and features of the present disclosure can be obtained, a description of the present disclosure is rendered by reference to specific embodiments thereof which are illustrated in the appended drawings. These drawings depict only exemplary embodiments of the present disclosure and are not therefore intended to limit the scope of the present disclosure.

FIG. 1 illustrates exemplary scenarios for SL positioning according to some embodiments of the present disclosure;

FIG. 2 illustrates a flowchart of an exemplary method for SL positioning according to some embodiments of the present disclosure;

FIG. 3 illustrates a flow chart of an exemplary method for determining candidate SL anchor UE(s) according to some embodiments of the present disclosure;

FIG. 4 illustrates a flow chart of another exemplary method for determining candidate SL anchor UE(s) according to some other embodiments of the present disclosure;

FIG. 5 illustrates an exemplary protocol stack for a discovery procedure according to some embodiments of the present disclosure;

FIG. 6 illustrates a flow chart of an exemplary method for determining candidate SL anchor UE(s) according to some embodiments of the present disclosure;

FIG. 7 illustrates a flow chart of another exemplary method for determining candidate SL anchor UE(s) according to some other embodiments of the present disclosure;

FIG. 8 illustrates a simplified block diagram of an exemplary apparatus according to some embodiments of the present disclosure; and

FIG. 9 illustrates a simplified block diagram of another exemplary apparatus according to some other embodiments of the present disclosure.

### DETAILED DESCRIPTION

The detailed description of the appended drawings is intended as a description of the currently preferred embodiments of the present invention, and is not intended to represent the only form in which the present invention may be practiced. It should be understood that the same or equivalent functions may be accomplished by different embodiments that are intended to be encompassed within the spirit and scope of the present invention.

While operations are depicted in the drawings in a particular order, persons skilled in the art will readily recognize that such operations need not be performed in the particular order shown or in sequential order, or that among all illustrated operations be performed, to achieve desirable results, sometimes one or more operations can be skipped. Further, the drawings can schematically depict one or more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing can be advantageous.

Reference will now be made in detail to some embodiments of the present disclosure, examples of which are illustrated in the accompanying drawings. To facilitate understanding, embodiments are provided under specific network architecture and new service scenarios, such as 3^{rd} generation partnership project (3GPP) 5G new radio (NR), 3GPP LTE, and so on. It is contemplated that along with the developments of network architectures and new service scenarios, all embodiments in the present disclosure are also applicable to similar technical problems; and moreover, the terminologies recited in the present disclosure may change, which should not affect the principle of the present disclosure.

A wireless communication system generally includes one or more base stations (BSs) and one or more UEs. In some embodiments of the present disclosure, a BS may be referred to as an access point, an access terminal, a base, a base unit, a macro cell, a Node-B, an enhanced Node-B, an evolved Node B (eNB), a gNB, a Home Node-B, a relay node, or a device, or described using other terminology used in the art. A BS is generally part of a radio access network that may include a controller communicably coupled to the BS.

In some embodiments of the present disclosure, UEs may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), road side units (RSUs), or the like. According to some embodiments of the present disclosure, a UE may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments, a UE may include wearable devices, such as smart watches, fitness bands, optical head-mounted displays, or the like. Moreover, a UE may be referred to as a subscriber unit, a mobile, a mobile station, a user, a terminal, a mobile terminal, a wireless terminal, a fixed terminal, a subscriber station, a user terminal, or a device, or described using other terminology used in the art.

When a location service request is initiated or occurs at a UE, the UE (referred to as target UE or location service (LCS) target UE) needs to know its own position. When the target UE is within a coverage area of a BS or network (i.e., in coverage), the target UE may get positioning information from the BS or network. When the target UE is outside a coverage area of any BS or network (i.e., out of coverage), the target UE cannot get positioning information from any BS or network. According to various embodiments of the present disclosure, regardless of in coverage or out of coverage, the target UE (also referred to as SL target UE) may select one or more other UEs to be anchor UE(s) (also referred to as SL anchor UE(s)), which may participate in SL positioning and help the SL target UE to acquire its position, e.g., by sending/receiving SL PRS and doing relevant measurements. The SL anchor UE should have positioning capability, and may be an RSU or any SL UE.

When performing SL positioning, the SL target UE and the SL anchor UE may be both in coverage (i.e., “both in coverage” scenario), or one in coverage and the other out of coverage (i.e., “partial coverage” scenario), or both out of coverage (i.e., “both out of coverage” scenario).

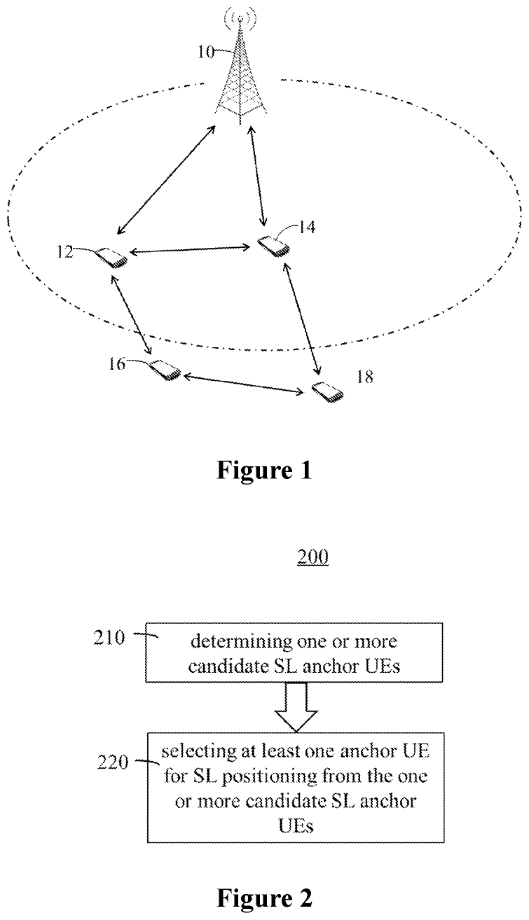

FIG. 1 illustrates exemplary scenarios for SL positioning according to some embodiments of the present disclosure.

As shown in FIG. 1, a wireless communication system may include one BS (e.g., BS 10) and four UEs (e.g., UE 12, UE 14, UE 16, and UE 18). The UE 12 and the UE 14 are within a coverage area of the BS 10 and may communicate with the BS 10 via Uu interface. The UE 16 and the UE 18 are outside the coverage area of the BS 10. The UE 12 may communicate with the UE 14 and the UE 16 via SL, and the UE 18 may communicate with the UE 14 and the UE 16 via SL. It should be understood that the wireless communication system may include more BSs and more or fewer UEs, and different types of UEs may be included.

In an embodiment, the UE 12 may act as an SL target UE. The UE 12 may select the UE 14 to be an SL anchor UE to assist the UE 12 to acquire its position, which is in the “both in coverage” scenario. Alternatively or additionally, the UE 12 may select the UE 16 to be an SL anchor UE to assist the UE 12 to acquire its position, which is in the “partial coverage” scenario. It should be understood that the UE 12 may alternatively or additionally select other SL anchor UE(s) not shown in FIG. 1.

In an embodiment, the UE 18 may act as an SL target UE. The UE 18 may select the UE 14 to be an SL anchor UE to assist the UE 18 to acquire its position, which is in the “partial coverage” scenario. Alternatively or additionally, the UE 18 may select the UE 16 to be an SL anchor UE to assist the UE 18 to acquire its position, which is in the “both out of coverage” scenario. It should be understood that the UE 18 may alternatively or additionally select other SL anchor UE(s) not shown in FIG. 1. The SL anchor UE(s) selected by the UE 18 may be different from the SL anchor UE(s) selected by the UE 12.

FIG. 2 illustrates a flowchart of an exemplary method 200 for SL positioning according to some embodiments of the present application. The method 200 may be performed by a UE that acts as an SL target UE (e.g., the UE 12 or the UE 18 in FIG. 1) or other apparatus with the like functions.

In operation 210, the SL target UE may determine one or more candidate SL anchor UEs, e.g., from one or more other UEs in proximity.

In operation 220, the SL target UE may select at least one anchor UE for SL positioning from the determined candidate SL anchor UE(s), i.e., select at least one SL anchor UE to assist the SL target UE to acquire position information of the SL target UE.

In some embodiments of the present disclosure, candidate SL anchor UE(s) may be determined based on a discovery procedure in a discovery layer.

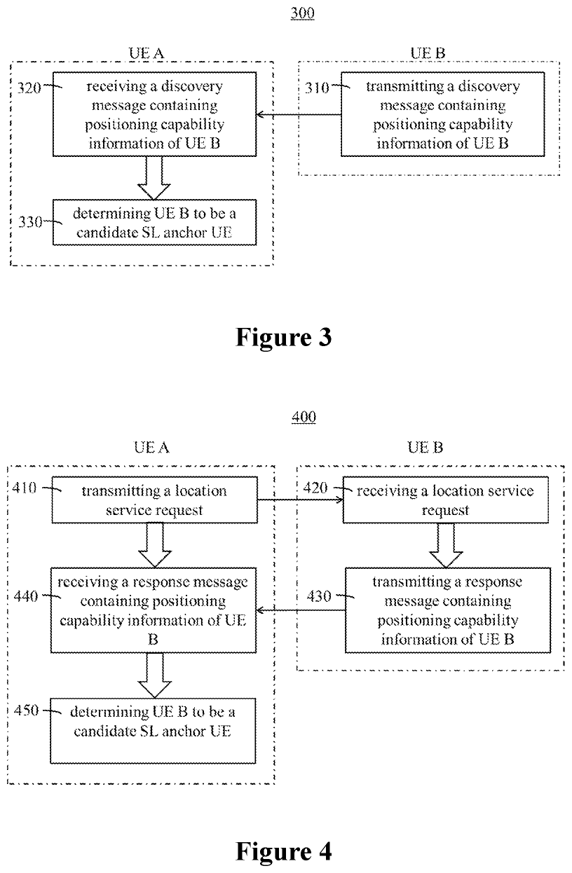

FIG. 3 illustrates a flow chart of an exemplary method 300 for determining candidate SL anchor UE(s) according to some embodiments of the present disclosure. Although method 300 performed by UE A and UE B is illustrated in a system level, persons skilled in the art can understand that the part of method 300 implemented in UE A and the part of method 300 implemented in UE B can be separately implemented and incorporated in other apparatus with the like functions.

According to some embodiments, UE B may announce its UE positioning capability that could be used by target UE(s) in proximity that has (have) permission to discover UE B. For example, in operation 310, UE B may transmit a discovery message containing positioning capability information of UE B. The positioning capability information of UE B may indicate the positioning capability of UE B. The positioning capability information may include at least one of static capability information (e.g., type(s) of positioning method(s) supported) and dynamic capability information (e.g., a total bandwidth available for making positioning measurements). In some embodiments, the discovery message is a broadcast message.

Target UE(s) may monitor discovery message(s) transmitted by other UE(s) in proximity. For example, in operation 320, a target UE (e.g., UE A) may receive the discovery message containing the positioning capability information of UE B.

In operation 330, UE A may determine UE B to be a candidate SL anchor UE.

In some embodiments, UE A may determine UE B to be a candidate SL anchor UE once UE A receives the discovery message containing the positioning capability information of UE B. In some other embodiments, UE A may determine UE B to be a candidate SL anchor UE when the positioning capability of UE B meets a criterion to serve as an anchor UE for UE A. The criterion may include that, for example, the anchor UE should support some specified positioning method, or a total bandwidth available for making positioning measurements should be larger than a specified threshold.

FIG. 4 illustrates a flow chart of an exemplary method 400 for determining candidate SL anchor UE(s) according to some embodiments of the present disclosure. Although method 400 performed by UE A and UE B is illustrated in a system level, persons skilled in the art can understand that the part of method 400 implemented in UE A and the part of method 400 implemented in UE B can be separately implemented and incorporated in other apparatus with the like functions.

UE A may be a target UE. In operation 410, UE A may transmit a location service request. In some embodiments, the location service request may contain an SL anchor UE discovery message. Alternatively or additionally, the location service request may contain a criterion to serve as an anchor UE for UE A. The criterion may include that, for example, the anchor UE should support some specified positioning method, or a total bandwidth available for making positioning measurements should be larger than a specified threshold. In some embodiments, the location service request is contained in a broadcast message.

Other UE(s) in proximity may receive the location service request transmitted by UE A. For example, in operation 420, UE B may receive the location service request from UE A.

In operation 430, UE B may transmit a response message to UE A in response to reception of the location service request, wherein the response message contains positioning capability information of UE B. The positioning capability information of UE B may indicate a positioning capability of UE B. The positioning capability information may include at least one of static capability information (e.g., type(s) of positioning method(s) supported) and dynamic capability information (e.g., a total bandwidth available for making positioning measurements).

In some embodiments, when the location service request contains a criterion to serve as an anchor UE for UE A, UE B may transmit the response message only when its positioning capability meets the criterion. The criterion may include that, for example, the anchor UE should support some specified positioning method, or a total bandwidth available for making positioning measurements should be larger than a specified threshold.

In operation 440, UE A may receive the response message containing the positioning capability information of UE B. Then, in operation 450, UE A may determine UE B to be a candidate SL anchor UE in response to reception of the response message.

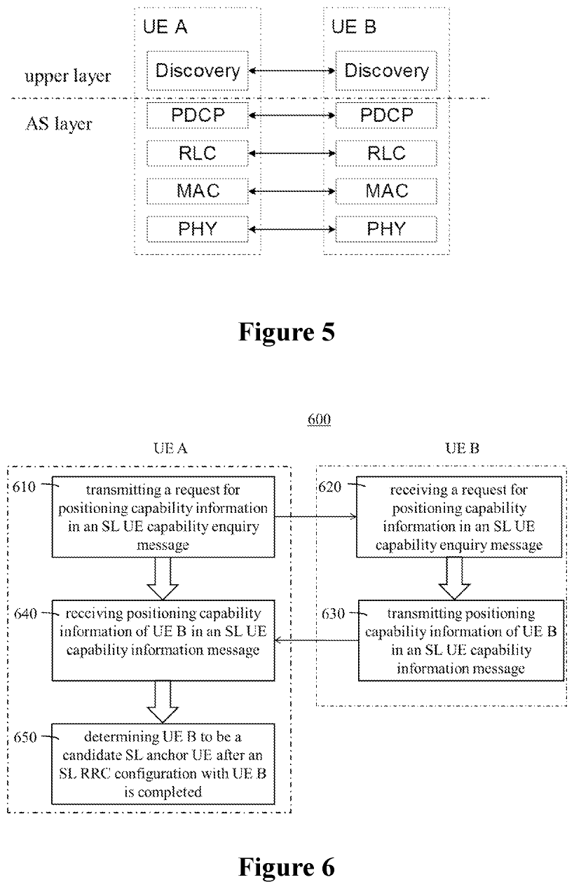

FIG. 5 illustrates an exemplary protocol stack for a discovery procedure according to some embodiments of the present disclosure. As described above, both method 300 and method 400 involve a discovery procedure. The protocol stack shown in FIG. 5 may apply to method 300 and method 400.

According to FIG. 5, the discovery protocol stack of a UE (e.g., UE A or UE B) may include an access stratum (AS) layer and an upper layer. The AS layer may include a physical (PHY) layer, a medium access control (MAC) layer, a radio link control (RLC) layer, and a packet data convergence protocol (PDCP) layer. The upper layer may include a discovery layer. It should be understood that the AS layer and the upper layer may include other layer(s) not shown in FIG. 5.

In some examples of method 300, to implement operation 310, the AS layer of UE B delivers the positioning capability information of UE B to the discovery layer of UE B, and then the discovery layer of UE B transfers the discovery message including the positioning capability information of UE B and other possible information to the AS layer of UE B for transmission.

To implement operation 320, the AS layer of UE A receives the discovery message from the AS layer of UE B, and delivers the received positioning capability information of UE B and other possible information contained in the discovery message to the discovery layer of UE A.

In some examples of method 400, to implement operation 410, the AS layer of UE A delivers the location service request to the discovery layer of UE A, and then the discovery layer of UE A transfers the location service request and other possible information to the AS layer of UE A for transmission.

To implement operation 420, the AS layer of UE B receives the location service request from the AS layer of UE A, and delivers the received location service request to the discovery layer of UE B.

To implement operation 430, the AS layer of UE B delivers the positioning capability information of UE B to the discovery layer of UE B, and then the discovery layer of UE B transfers the response message including the positioning capability information of UE B and other possible information to the AS layer of UE B for transmission.

To implement operation 440, the AS layer of UE A receives the response message from the AS layer of UE B, and delivers the received positioning capability information of UE B and other possible information contained in the response message to the discovery layer of UE A.

In some embodiments of the present disclosure, candidate SL anchor UE(s) may be determined based on an SL UE capability transfer procedure.

FIG. 6 illustrates a flow chart of an exemplary method 600 for determining candidate SL anchor UE(s) according to some embodiments of the present disclosure. Although method 600 performed by UE A and UE B is illustrated in a system level, persons skilled in the art can understand that the part of method 600 implemented in UE A and the part of method 600 implemented in UE B can be separately implemented and incorporated in other apparatus with the like functions.

UE A may be a target UE. In operation 610, UE A may transmit a request for positioning capability information in an SL UE capability enquiry message (e.g., UECapabilityEnquirySidelink message as specified in 3GPP specifications) to UE B.

In some embodiments, UE A may transmit the request for positioning capability information when a positioning capability or criterion required for serving as an anchor UE for UE A changes.

In operation 620, UE B may receive the request for positioning capability information in the SL UE capability enquiry message from UE A.

In operation 630, UE B may transmit positioning capability information of UE B in an SL UE capability information message (e.g., UECapabilityInformationSidelink message as specified in 3GPP specifications) to UE A. The positioning capability information of UE B may indicate a positioning capability of UE B. The positioning capability information may include at least one of static capability information (e.g., type(s) of positioning method(s) supported) and dynamic capability information (e.g., a total bandwidth available for making positioning measurements).

In operation 640, UE A may receive the positioning capability information of UE B in the SL UE capability information message from UE B.

In operation 650, after an SL RRC configuration with UE B is completed (i.e., an SL RRC connection between UE A and UE B is completed), UE A may determine UE B to be a candidate SL anchor UE.

In some embodiments, in operation 650, UE A may further determine whether the positioning capability of UE B meets a criterion to serve as an anchor UE for UE A. The criterion may include that, for example, the anchor UE should support some specified positioning method, or a total bandwidth available for making positioning measurements should be larger than a specified threshold. When the positioning capability of UE B meets the criterion, UE A may determine UE B to be a candidate SL anchor UE.

In some embodiments, UE B may further transmit its positioning capability information to target UE(s) (e.g., UE A) when its positioning capability changes.

In some embodiments of the present disclosure, candidate SL anchor UE(s) may be determined based on PRS transmission in AS layer.

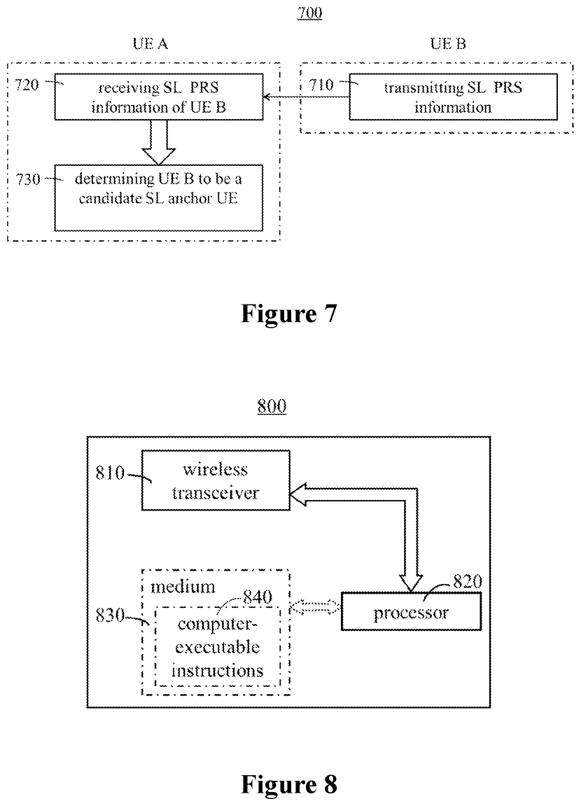

FIG. 7 illustrates a flow chart of an exemplary method 700 for determining candidate SL anchor UE(s) according to some embodiments of the present disclosure. Although method 700 performed by UE A and UE B is illustrated in a system level, persons skilled in the art can understand that the part of method 700 implemented in UE A and the part of method 700 implemented in UE B can be separately implemented and incorporated in other apparatus with the like functions.

In operation 710, UE B may transmit SL PRS information.

In some embodiments, the SL PRS information may contain information identifying UE B explicitly or implicitly. For example, the information identifying UE B may include a layer 2 destination identifier (ID), a cell-radio network temporary ID (C-RNTI), or the like.

In some embodiments, UE B may transmit the SL PRS information in a dedicated time and frequency resource, for example, in the case that SL PRS is configured per resource pool, or UE A may know when (time resource) and where (frequency resource) to receive the SL PRS information.

UE A may be a target UE. In operation 720, UE A may receive the SL PRS information of UE B.

In some embodiments, UE A may receive the SL PRS information in the dedicated time and frequency resource

In some embodiments, UE A may receive, from an LMF, available SL PRS configurations via LPP signaling before receiving the SL PRS information from UE B.

In some embodiments, the LMF may provide available SL PRS configurations or information of UE B to a BS via NR Positioning Protocol A (NRPPa) information, and the BS may inform the available SL PRS configurations or information of UE B to UE A via RRC signaling. In some embodiments, the BS may broadcast the available SL PRS configuration or information in Positioning System Information Block (PosSIB), and UE A or UE-B may receive the SL PRS configuration or information from PosSIB.

In operation 730, UE A may determine UE B to be a candidate SL anchor UE in response to reception of the SL PRS information.

As described above with respect to FIGS. 3-7, UE B may transmit positioning capability information of UE B (e.g., in method 300, method 400, or method 600) and/or transmit SL PRS information (e.g., in method 700), such that a target UE (e.g., UE A) may determine whether to select UE B to be a candidate SL anchor UE.

According to various embodiments of the present disclosure, a target UE may determine one or more candidate SL anchor UEs based on method 300, method 400, method 600, method 700, or any combination thereof.

According to some embodiments of the present disclosure, a target UE may select at least one anchor UE for SL positioning form the one or more candidate SL anchor UEs based on at least one of the followings:
positioning capability information of the one or more candidate SL anchor UEs;
SL radio signal strength measurement results associated with the one or more candidate SL anchor UEs; or
types of the one or more candidate SL anchor UEs.

In some embodiments, the positioning capability information may include static positioning capability information and/or dynamic positioning capability information.

For example, the static positioning capability information may include type(s) of positioning mode(s) used by the candidate SL anchor UE(s), e.g., GNSS-positioning, RAT-dependent positioning, absolute positioning or relative positioning meeting set-1 requirements, absolute positioning or relative positioning meeting set-2 requirements, or absolute positioning or relative positioning meeting set-3 requirements.

For example, the dynamic positioning capability information may include a total bandwidth available for making positioning measurements.

In some embodiments, the SL radio signal strength measurement results may include radio signal strength measurement results of SL discovery message(s).

In some embodiments, the SL radio signal strength measurement results may include SL-RSRP value(s) (e.g., demodulation reference signal (DMRS) measurement) on SL unicast link(s) between the target UE and the candidate SL anchor UE(s).

In some embodiments, the type of a candidate SL anchor UE may include a stationary RSU, or a moving UE with specific velocity, height, direction or angle.

In some embodiments, the target UE may select at least one anchor UE for SL positioning from the one or more candidate SL anchor UEs according to a predefined criterion, or according to actual requirements.

In some embodiments, when selecting at least one anchor UE for SL positioning from the one or more candidate SL anchor UEs, the target UE may give a higher priority to a candidate SL anchor UE supporting a positioning mode with a higher accuracy and/or a lower latency.

For example, the GNSS positioning mode has a higher accuracy and a lower latency than the RAT-dependent positioning mode. When selecting at least one anchor UE for SL positioning from the one or more candidate SL anchor UEs, the target UE may give a candidate SL anchor UE supporting GNSS positioning mode a higher priority to be selected than a candidate SL anchor UE supporting RAT-dependent positioning mode.

For example, a positioning mode meeting set-3 requirements has a higher accuracy than a positioning mode meeting set-2 or set-1 requirements. When selecting at least one anchor UE for SL positioning from the one or more candidate SL anchor UEs, the target UE may give a candidate SL anchor UE supporting a positioning mode meeting set-3 requirements a higher priority to be selected as an SL anchor UE than a candidate SL anchor UE supporting a positioning mode meeting set-2 or set-1 requirements.

In some embodiments, when selecting at least one anchor UE for SL positioning from the one or more candidate SL anchor UEs, the target UE may give a candidate SL anchor UE supporting a wider bandwidth a higher priority to be selected than a candidate SL anchor UE supporting a narrower bandwidth.

In some embodiments, when selecting at least one anchor UE for SL positioning from the one or more candidate SL anchor UEs, the target UE may give a candidate SL anchor UE with a higher radio signal strength of SL discovery message a higher priority to be selected than a candidate SL anchor UE with a lower radio signal strength of SL discovery message.

In some embodiments, when selecting at least one anchor UE for SL positioning from the one or more candidate SL anchor UEs, the target UE may give a first candidate SL anchor UE with a higher SL RSRP value on an SL unicast link between the first candidate SL anchor UE and the target UE a higher priority to be selected than a second candidate SL anchor UE with a lower SL-RSRP value on an SL unicast link between the second candidate SL anchor UE and the target UE when the first candidate SL anchor UE and the second candidate SL anchor UE are connected to the target UE.

In some embodiments, when selecting at least one anchor UE for SL positioning from the one or more candidate SL anchor UEs, the target UE may give a candidate SL anchor UE which is an RSU a higher priority to be selected than a candidate SL anchor UE which is a moving UE. In some other embodiments, the target UE may give a higher priority to a candidate SL anchor UE which is a moving UE.

In some embodiments, when selecting at least one anchor UE for SL positioning from the one or more candidate SL anchor UEs, the target UE may give a candidate SL anchor UE in SL RRC connection with the target UE a higher priority to be selected than a candidate SL anchor UE without SL RRC connection with the target UE.

In some embodiments, the target UE may select at least one candidate SL anchor UE with a specific UE type to be the at least one anchor UE for SL positioning. In some embodiments, the specific UE type may be an RSU, or a moving UE with certain velocity, height, direction or angle, or a UE meeting special requirements.

It would be appreciated that, according to the present disclosure, when selecting at least one anchor UE for SL positioning from the one or more candidate SL anchor UEs, the target UE may take into consideration one or more factors listed above.

According to some embodiments of the present disclosure, after selecting at least one anchor UE for SL positioning, the target UE may establish an SL RRC connection with the selected at least one anchor UE in the case that the at least one anchor UE is not in SL RRC connection with the target UE. Furthermore, the target UE may receive positioning capability information of the selected at least one anchor UE in SL UE capability information from the selected at least one anchor UE.

In some cases, the target UE may perform SL anchor UE re-selection to guarantee availability of SL anchor UE(s). The SL anchor UE re-selection may be performed based on the same factors as described above. According to various embodiments of the present disclosure, the target UE may perform SL anchor UE re-selection in response to at least one of the following conditions:
A change in a positioning capability requirement of the target UE for SL positioning meets a first predefined condition. In some embodiments, the first predefined condition includes at least one of
   a change in an accuracy requirement for SL positioning satisfies a specified threshold, for example, the accuracy requirement changes from the set-1 or set-2 requirement to the set-3 requirement; or
   a change in a latency requirement for SL positioning satisfies a specified threshold.
A change in a positioning capability of an anchor UE for SL positioning meets a second predefined condition. In some embodiments, when a change in a positioning capability of an anchor UE meets the second predefined condition, the anchor UE may transmit an indication of updated positioning capability to the target UE to trigger the SL anchor UE re-selection. In some embodiments, the second predefined condition includes at least one of
   the positioning capability of an anchor UE to support SL positioning for the target UE is unavailable, for example, GNSS positioning of an anchor UE becomes unavailable;
   an anchor UE for SL positioning moves out of coverage of a network; or
   a total bandwidth available for making positioning measurements by an anchor UE for SL positioning is lower than a configured or predefined threshold.
The target UE enters, leaves, or remains within a predefined area. In some embodiments, the area is pre-defined by an LCS client or an application function (AF) as a geographical area or as a geopolitical name of an area. In some embodiments, the area is translated and pre-defined by a public land mobile network (PLMN) as an identity of at least one radio cell or tracking area.
The target UE moves by more than a predefined straight-line distance from a previous location.
The target UE receives an SL anchor UE re-selection indication via an LPP signaling from an LMF, an RRC signaling from a BS, or from an anchor UE for SL positioning. In some embodiments, the anchor UE may first receive the SL anchor UE re-selection indication from a BS and then transmit it to the target UE.
No SL PRS information is received within a duration of a timer pre-configured or configured by a network, wherein the timer is shorter than a timer indicating a radio link failure (e.g., timer T400).
An SL-RSRP measurement value on an SL unicast link between the target UE and an anchor UE for SL positioning is within a specified threshold during a specified time window.
An SL radio link between the target UE and an anchor UE for SL positioning fails.

In some embodiments, the target UE may start a timer after selecting or reselecting at least one anchor UE for SL positioning, and prohibit SL anchor UE re-selection when the timer is running. A value of the timer may be pre-configured or configured by a network. The timer can be used to prohibit the target UE from performing SL anchor UE re-selection too frequently.

The present disclosure is not limited to the various provided methods and embodiments mentioned above, and these methods and embodiments may be reasonably and flexibly combined and/or adjusted with the development of the wireless communication technologies.

FIG. 8 illustrates a simplified block diagram of an exemplary apparatus 800 according to various embodiments of the present disclosure. The apparatus 800 may be or include at least a part of a UE or other device having similar functionality. The apparatus 800 may act as a target UE.

As shown in FIG. 8, the apparatus 800 may include at least a wireless transceiver 810 and a processor 820, wherein the wireless transceiver 810 may be coupled to the processor 820. In some embodiments, the apparatus 800 may include a non-transitory computer-readable medium 830 with computer-executable instructions 840 stored thereon, wherein the non-transitory computer-readable medium 830 may be coupled to the processor 820, and the computer-executable instructions 840 may be configured to be executable by the processor 820. In some embodiments, the wireless transceiver 810, the non-transitory computer-readable medium 830, and the processor 820 may be coupled to each other via one or more buses.

Although in FIG. 8, elements such as the wireless transceiver 810, the non-transitory computer-readable medium 830, and the processor 820 are described in the singular, the plural is contemplated unless limitation to the singular is explicitly stated. In some embodiments of the present disclosure, the wireless transceiver 810 may be implemented by a transmitter and a receiver. In certain embodiments of the present disclosure, the apparatus 800 may further include other components for actual usage.

The processor 820 may be configured to perform, e.g., with the wireless transceiver 810, any of the various methods and embodiments described above which are performed by a target UE according to the present disclosure.

In some embodiments of the present disclosure, the processor 820 is configured to: determine one or more candidate SL anchor UEs, and select at least one anchor UE for SL positioning from the one or more candidate SL anchor UEs.

In some embodiments, the processor 820 is configured to determine the one or more candidate SL anchor UEs based on a discovery procedure in a discovery layer.

In some embodiments, to determine the one or more candidate SL anchor UEs, the processor 820 is configured to: receive, with the wireless transceiver 810, a discovery message containing positioning capability information of a UE, and determine the UE to be a candidate SL anchor UE.

In some embodiments, the processor 820 is configured to determine the UE to be a candidate SL anchor UE when a positioning capability of the UE meets a criterion to serve as an anchor UE for the apparatus 800.

In some embodiments, to determine the one or more candidate SL anchor UEs, the processor 820 is configured to: transmit, with the wireless transceiver 810, a location service request; receive, with the wireless transceiver 810, a response message containing positioning capability information of a UE; and determine the UE to be a candidate SL anchor UE.

In some embodiments, the location service request contains at least one of an SL anchor UE discovery message and a criterion to serve as an anchor UE for the apparatus 800.

In some embodiments, the processor 820 is further configured to: establish an SL RRC connection with the selected at least one anchor UE; and receive, with the wireless transceiver 810, positioning capability information of the selected at least one anchor UE in SL UE capability information from the selected at least one anchor UE.

In some embodiments, the processor 820 is configured to determine the one or more candidate SL anchor UEs based on an SL UE capability transfer procedure.

In some embodiments, to determine the one or more candidate SL anchor UEs, the processor 820 is configured to: transmit, with the wireless transceiver 810, a request for positioning capability information in an SL UE capability enquiry message to a UE; receive, with the wireless transceiver 810, positioning capability information of the UE in an SL UE capability information message from the UE; and determine the UE to be a candidate SL anchor UE after an SL RRC configuration with the UE is completed.

In some embodiments, the processor 820 is configured to transmit, with the wireless transceiver 810, the request for positioning capability information to the UE when a positioning capability or criterion required for serving as an anchor UE for the apparatus 800 changes.

In some embodiments, to determine the one or more candidate SL anchor UEs, the processor 820 is configured to: receive, with the wireless transceiver 810, SL PRS information from a UE; and determine the UE to be a candidate SL anchor UE.

In some embodiments, the SL PRS information contains information identifying the UE.

In some embodiments, the SL PRS information is received in a dedicated time and frequency resource.

In some embodiments, the processor 820 is further configured to: receive, with the wireless transceiver 810, an available SL PRS configuration from an LMF via an LPP signaling, or from a base station via an RRC signaling.

In some embodiments, the processor 820 is configured to select the at least one anchor UE for SL positioning from the one or more candidate SL anchor UEs based on at least one of the followings: positioning capability information of the one or more candidate SL anchor UEs; SL radio signal strength measurement results associated with the one or more candidate SL anchor UEs; or types of the one or more candidate SL anchor UEs.

In some embodiments, to select the at least one anchor UE for SL positioning from the one or more candidate SL anchor UEs, the processor 820 is configured to: give a candidate SL anchor UE supporting GNSS positioning mode a higher priority to be selected than a candidate SL anchor UE supporting RAT-dependent positioning mode; and/or give a candidate SL anchor UE supporting a wider bandwidth a higher priority to be selected than a candidate SL anchor UE supporting a narrower bandwidth.

In some embodiments, to select the at least one anchor UE for SL positioning from the one or more candidate SL anchor UEs, the processor 820 is configured to: give a candidate SL anchor UE with a higher radio signal strength of SL discovery message a higher priority to be selected than a candidate SL anchor UE with a lower radio signal strength of SL discovery message; and/or give a first candidate SL anchor UE with a higher SL RSRP value on an SL unicast link between the first candidate SL anchor UE and the apparatus 800 a higher priority to be selected than a second candidate SL anchor UE with a lower SL-RSRP value on an SL unicast link between the second candidate SL anchor UE and the apparatus 800 when the first candidate SL anchor UE and the second candidate SL anchor UE are connected to the apparatus 800.

In some embodiments, the processor 820 is configured to select at least one candidate SL anchor UE with a specific UE type to be the at least one anchor UE for SL positioning.

In some embodiments, the processor 820 is further configured to: start a timer after selecting the at least one anchor UE for SL positioning; and prohibit SL anchor UE re-selection when the timer is running, wherein a value of the timer is pre-configured or configured by a network.

In some embodiments, the processor 820 is further configured to perform SL anchor UE re-selection in response to at least one of the following conditions:
a change in a positioning capability requirement of the apparatus 800 for SL positioning meets a first predefined condition;
a change in a positioning capability of an anchor UE for SL positioning meets a second predefined condition;
the apparatus 800 enters, leaves, or remains within a predefined area;
the apparatus 800 moves by more than a predefined straight-line distance from a previous location;
the apparatus 800 receives an SL anchor UE re-selection indication via an LPP signaling from an LMF, an RRC signaling from a base station, or from an anchor UE for SL positioning;
no SL PRS information is received within a duration of a timer pre-configured or configured by a network, wherein the timer is shorter than a timer indicating a radio link failure;
an SL-RSRP measurement value on an SL unicast link between the apparatus 800 and an anchor UE for SL positioning is within a specified threshold during a specified time window; or
an SL radio link between the apparatus 800 and an anchor UE for SL positioning fails.

In some embodiments, the first predefined condition incudes at least one of: a change in an accuracy requirement for SL positioning satisfies a specified threshold; or a change in a latency requirement for SL positioning satisfies a specified threshold.

In some embodiments, the second predefined condition includes at least one of: the positioning capability to support SL positioning for the apparatus 800 is unavailable; the anchor UE for SL positioning moves out of coverage of a network; or a total bandwidth available for making positioning measurements by the anchor UE for SL positioning is lower than a threshold.

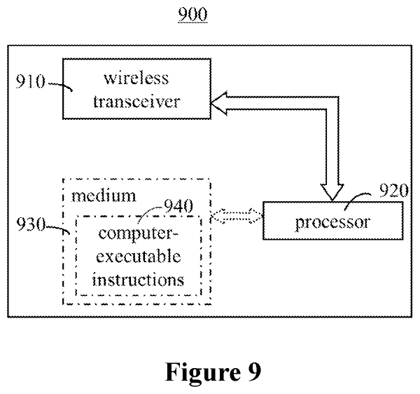

FIG. 9 illustrates a simplified block diagram of an exemplary apparatus 900 according to various embodiments of the present disclosure. The apparatus 900 may be or include at least a part of a UE or other device having similar functionality. The apparatus 900 may have a positioning capability.

As shown in FIG. 9, the apparatus 900 may include at least a wireless transceiver 910 and a processor 920, wherein the wireless transceiver 910 may be coupled to the processor 920. In some embodiments, the apparatus 900 may include a non-transitory computer-readable medium 930 with computer-executable instructions 940 stored thereon, wherein the non-transitory computer-readable medium 930 may be coupled to the processor 920, and the computer-executable instructions 940 may be configured to be executable by the processor 920. In some embodiments, the wireless transceiver 910, the non-transitory computer-readable medium 930, and the processor 820 may be coupled to each other via one or more buses.

Although in FIG. 9, elements such as the wireless transceiver 910, the non-transitory computer-readable medium 930, and the processor 920 are described in the singular, the plural is contemplated unless limitation to the singular is explicitly stated. In some embodiments of the present disclosure, the wireless transceiver 910 may be implemented by a transmitter and a receiver. In certain embodiments of the present disclosure, the apparatus 900 may further include other components for actual usage.

The processor 920 may be configured to perform, e.g., with the wireless transceiver 910, any of the various methods and embodiments described above which are performed by a UE according to the present disclosure.

In some embodiments of the present disclosure, the processor 920 is configured to perform at least one of: transmitting, with the wireless transceiver 910, positioning capability information of the apparatus 900; and transmitting, with the wireless transceiver 910, SL PRS information.

In some embodiments, the processor 920 is configured to transmit, with the wireless transceiver 910, the positioning capability information of the apparatus 900 in a discovery message.

In some embodiments, the processor 920 is configured to transmit, with the wireless transceiver 910, the positioning capability information of the apparatus 900 in a response message to a UE in response to a location service request received from the UE.

In some embodiments, the location service request contains at least one of an SL anchor UE discovery message and a criterion to serve as an anchor UE for the UE.

In some embodiments, the processor 920 is configured to transmit, with the wireless transceiver 910, the positioning capability information of the apparatus 900 to the UE when a positioning capability of the apparatus 900 meets the criterion contained in the location service request.

In some embodiments, the processor 920 is configured to transmit, with the wireless transceiver 910, positioning capability information of the apparatus 900 in an SL UE capability information message to a UE in response to a request for positioning capability information received in an SL UE capability enquiry message from the UE.

In some embodiments, the processor 920 is configured to transmit, with the wireless transceiver 910, the positioning capability information of the apparatus 900 when a positioning capability of the apparatus 900 changes.

In some embodiments, the SL PRS information contains information identifying the apparatus 900.

In some embodiments, the processor 920 is configured to transmit, with the wireless transceiver, the SL PRS information in a dedicated time and frequency resource.

In some embodiments, the processor 920 is further configured to transmit, with the wireless transceiver 910, an indication of updated positioning capability to a UE when a change in a positioning capability of the apparatus 900 meets a predefined condition, wherein the apparatus 900 is serving as an anchor UE for SL positioning of the UE.

In some embodiments, the predefined condition includes at least one of: the positioning capability to support SL positioning for the UE is unavailable; the apparatus 900 moves out of coverage of a network; or a total bandwidth available for making positioning measurements by the apparatus 900 is lower than a threshold.

In some embodiments, the processor 900 is further configured to: receive, with the wireless transceiver 910, an SL anchor UE re-selection indication from a BS; and transmit, with the wireless transceiver 910, the SL anchor UE re-selection indication to a UE, wherein the apparatus 900 is serving as an anchor UE for SL positioning of the UE.

In various example embodiments, the processor 820 or 920 may include, but is not limited to, at least one hardware processor, including at least one microprocessor such as a CPU, a portion of at least one hardware processor, and any other suitable dedicated processor such as those developed based on for example Field Programmable Gate Array (FPGA) and Application Specific Integrated Circuit (ASIC). Further, the processor 820 or 920 may also include at least one other circuitry or element not shown in FIG. 8 or FIG. 9.

In various example embodiments, the non-transitory computer-readable medium 830 or 930 may include at least one storage medium in various forms, such as a volatile memory and/or a non-volatile memory. The volatile memory may include, but is not limited to, for example, an RAM, a cache, and so on. The non-volatile memory may include, but is not limited to, for example, an ROM, a hard disk, a flash memory, and so on. Further, the non-transitory computer-readable mediums 830 or 930 may include, but is not limited to, an electric, a magnetic, an optical, an electromagnetic, an infrared, or a semiconductor system, apparatus, or device or any combination of the above.

Further, in various example embodiments, the exemplary apparatus 800 or 900 may also include at least one other circuitry, element, and interface, for example antenna element, and the like.

In various example embodiments, the circuitries, parts, elements, and interfaces in the exemplary apparatus 800 or 900 may be coupled together via any suitable connections including, but not limited to, buses, crossbars, wiring and/or wireless lines, in any suitable ways, for example electrically, magnetically, optically, electromagnetically, and the like.

The methods of the present disclosure can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

While the present disclosure has been described with specific embodiments thereof, it is evident that many alternatives, modifications, and variations will be apparent to those skilled in the art. For example, various components of the embodiments may be interchanged, added, or substituted in other embodiments. Also, all of the elements shown in each figure are not necessary for operation of the disclosed embodiments. For example, one skilled in the art of the disclosed embodiments would be capable of making and using the teachings of the present disclosure by simply employing the elements of the independent claims. Accordingly, the embodiments of the present disclosure as set forth herein are intended to be illustrative, not limiting. Various changes may be made without departing from the spirit and scope of the present disclosure.

The terms “includes,” “comprising,” “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The terms “including,” “having,” and the like, as used herein, are defined as “comprising.”

1. A first user equipment (UE), comprising:
at least one memory; and
at least one processor coupled with the at least one memory and configured to cause the first UE to:
determine one or more candidate sidelink (SL) anchor UEs; and
select at least one anchor UE for SL positioning from the one or more candidate SL anchor UEs.

2. The first UE of claim 1, wherein the at least one processor is configured to determine the one or more candidate SL anchor UEs based on a discovery procedure in a discovery layer.

3. The first UE of claim 2, wherein the at least one processor is configured to determine the one or more candidate SL anchor UEs by:
receiving a discovery message containing positioning capability information of a second UE, and determining the second UE to be a candidate SL anchor UE;
receiving a discovery message containing positioning capability information of a second UE, and determining the second UE to be a candidate SL anchor UE in response to that a positioning capability of the second UE meets a criterion to serve as an anchor UE for the first UE; or
transmitting a location service request, receiving response message containing positioning capability information of a second UE, and determining the second UE to be a candidate SL anchor UE, wherein the location service request contains at least one of an SL anchor UE discovery message and a criterion to serve as an anchor UE for the first UE.

4. The first UE of claim 1, wherein the at least one processor is further configured to cause the first UE to:
establish an SL radio resource control (RRC) connection with the selected at least one anchor UE; and
receive positioning capability information of the selected at least one anchor UE in SL UE capability information from the selected at least one anchor UE.

5. The first UE of claim 1, wherein the at least one processor is configured to determine the one or more candidate SL anchor UEs based on an SL UE capability transfer procedure.

6. The first UE of claim 5, wherein the at least one processor is configured to determine the one or more candidate SL anchor UEs:
transmitting a request for positioning capability information in an SL UE capability enquiry message to a second UE;
receiving positioning capability information of the second UE in an SL UE capability information message from the second UE; and
determining the second UE to be a candidate SL anchor UE after an SL RRC configuration with the second UE is completed.

7. The first UE of claim 1, wherein the at least one processor is configured to determine the one or more candidate SL anchor UEs by:
receiving SL positioning reference signal (PRS) information from a second UE; and
determining the second UE to be a candidate SL anchor UE.

8. The first UE of claim 1, wherein the at least one processor is configured to select the at least one anchor UE for SL positioning from the one or more candidate SL anchor UEs based on:
positioning capability information of the one or more candidate SL anchor UEs;
SL radio signal strength measurement results associated with the one or more candidate SL anchor UEs; or
types of the one or more candidate SL anchor UEs.

9. (canceled)

10. The first UE of claim 1, wherein the at least one processor is further configured to cause the first UE to perform SL anchor UE re-selection in response to at least one of the following conditions:
a change in a positioning capability requirement of the first UE for SL positioning meets a first predefined condition;
a change in a positioning capability of an anchor UE for SL positioning meets a second predefined condition;
the first UE enters, leaves, or remains within a predefined area;
the first UE moves by more than a predefined straight-line distance from a previous location;
the first UE receives an SL anchor UE re-selection indication via a long term evolution (LTE) positioning protocol (LPP) signaling from location management function (LMF), a radio resource control (RRC) signaling from a base station, or from an anchor UE for SL positioning;
no SL positioning reference signal (PRS) information is received within a duration of a timer pre-configured or configured by a network, wherein the timer is shorter than a timer indicating a radio link failure;
an SL-RSRP (reference signal received power) measurement value on an SL unicast link between the first UE and an anchor UE for SL positioning is within a specified threshold during a specified time window; or
an SL radio link between the first UE and an anchor UE for SL positioning fails.

11. A second user equipment (UE), comprising:
at least one memory; and
at least one processor coupled with the at least one memory and configured to cause the second UE to:
transmit positioning capability information of the second UE; and
transmit sidelink (SL) positioning reference signal (PRS) information.

12. The second UE of claim 11, wherein the at least one processor is configured to:
transmit the positioning capability information of the second UE in a discovery message; or
transmit the positioning capability information of the second UE in a response message to a first UE in response to a location service request received from the first UE, wherein the location service request contains at least one of an SL anchor UE discovery message and a criterion to serve as an anchor UE for the first UE.

13. The second UE of claim 12, wherein the at least one processor is configured to transmit, with the wireless transceiver, the positioning capability information of the second UE to the first UE when a positioning capability of the second UE meets the criterion contained in the location service request.

14. The second UE of claim 11, wherein the at least one processor is configured to:
transmit the positioning capability information of the second UE in an SL UE capability information message to a first UE in response to a request for positioning capability information received in an SL UE capability enquiry message from the first UE;
transmit the positioning capability information of the second UE when a positioning capability of the second UE changes; or
transmit an indication of updated positioning capability to a first UE when a change in a positioning capability of the second UE meets a predefined condition, wherein the second UE is serving as an anchor UE for SL positioning of the first UE, and the predefined condition comprises at least one of:
the positioning capability of the second UE to support SL positioning for the first UE is unavailable;
the second UE moves out of coverage of a network; or
a total bandwidth available for making positioning measurements by the second UE is lower than a threshold.

15. The second UE of claim 11, wherein the at least one processor is further configured to:
receive an SL anchor UE re-selection indication from a base station; and
transmit the SL anchor UE re-selection indication to a first UE, wherein the second UE is serving as an anchor UE for SL positioning of the first UE.

16. The first UE of claim 1, wherein the at least one processor is configured to select at least one candidate SL anchor UE with a specific UE type to be the at least one anchor UE for SL positioning.

17. A processor for wireless communication, comprising:
at least one controller coupled with at least one memory and configured to cause the processor to:
determine one or more candidate sidelink (SL) anchor UEs; and
select at least one anchor UE for SL positioning from the one or more candidate SL anchor UEs.

18. The processor of claim 17, wherein the at least one controller is configured to determine the one or more candidate SL anchor UEs based on a discovery procedure in a discovery layer.

19. The processor of claim 18, wherein the at least one controller is configured to determine the one or more candidate SL anchor UEs by:
receiving a discovery message containing positioning capability information of a second UE, and determining the second UE to be a candidate SL anchor UE;
receiving a discovery message containing positioning capability information of a second UE, and determining the second UE to be a candidate SL anchor UE in response to that a positioning capability of the second UE meets a criterion to serve as an anchor UE for the processor; or
transmitting a location service request, receiving a response message containing positioning capability information of a second UE, and determining the second UE to be a candidate SL anchor UE, wherein the location service request contains at least one of an SL anchor UE discovery message and a criterion to serve as an anchor UE for the processor.

20. The processor of claim 17, wherein the at least one controller is further configured to cause the processor to:
establish an SL radio resource control (RRC) connection with the selected at least one anchor UE; and
receive positioning capability information of the selected at least one anchor UE in SL UE capability information from the selected at least one anchor UE.

21. A processor for wireless communication, comprising:
at least one controller coupled with at least one memory and configured to cause the processor to:
transmit positioning capability information of the processor; and
transmit sidelink (SL) positioning reference signal (PRS) information.
